(19) United States
(12) Patent Application Publication
(10) Pub. No.: US 2013/0327992 A1
(43) Pub. Date: Dec. 12, 2013

(54) CORROSION RESISTANT ADDITIVE COMPOSITIONS AND COATING COMPOSITIONS EMPLOYING THE SAME

(71) Applicant: CBI Polymers, Inc., Honolulu, HI (US)

(72) Inventors: Garry J. Edgington, Honolulu, HI (US); Andreas Mylonakis, San Jose, CA (US)

(73) Assignee: CBI POLYMERS, INC., Honolulu, HI (US)

(21) Appl. No.: 13/915,847

(22) Filed: Jun. 12, 2013

Related U.S. Application Data
(60) Provisional application No. 61/658,449, filed on Jun. 12, 2012.

(51) Int. Cl. C09D 5/08

(52) U.S. Cl. CPC C09D 5/086
USPC 252/389.24; 252/390; 252/392; 252/389.1; 252/391; 252/389.5; 252/389.53; 252/389.51; 252/389.4; 252/389.52; 252/389.62

(57) ABSTRACT

The disclosed invention relates to corrosion resistant additive composition comprising an aniline oligomer and a catalyst. The invention also relates to a coating composition comprising the foregoing corrosion resistant additive composition and a resin that is reactive with the aniline oligomer, the catalyst being present at an effective concentration to effect room temperature cure of the coating composition.

This application claims priority under 35 U.S.C. §119(e) to U.S. Provisional Application Ser. No. 61/658,449 filed Jun. 12, 2012. This prior application is incorporated herein by reference.

### TECHNICAL FIELD

This invention relates to corrosion resistant additive compositions, and more particularly to corrosion resistant additive compositions comprising an aniline oligomer and a catalyst. The invention relates to coating compositions containing the corrosion resistant additive composition and an effective amount of the catalyst to effect room temperature cure of the coating composition.

### BACKGROUND

Current methods of corrosion protection, including marine coatings that contain hexavalent chromium, volatile organic compounds (VOCs) and heavy metals as corrosion inhibitors.

### SUMMARY

The problem with these methods is that they are coming under increasing scrutiny under EPA, OSHA and other federal and environmental agencies. There is a need within the coatings industry for corrosion inhibitors that can replace traditional inorganic compounds used as anticorrosive agents. This invention provides a solution to this problem by providing a corrosion resistant additive composition that contains one or more aniline oligomers and a catalyst. Coating compositions may be provided using these corrosion resistant additive compositions wherein the coating compositions comprise a resin that is reactive with the aniline oligomers and cure at room temperature.

This invention relates to a corrosion resistant additive composition comprising an aniline oligomer with at least one amine functional group and a catalyst, wherein the catalyst comprises a cationic catalyst, anionic catalyst, imidazole, alcohol, tertiary amine, secondary amine, alkoxide, phenol, carboxylic acid, Lewis acid, carboxylic acid anhydride, sulfur containing compound, metal halide, a salt or complex of any of the foregoing catalysts, or a mixture of two or more of any of the foregoing. The invention relates to a composition, which may be in the form of a coating composition, which comprises the foregoing corrosion resistant additive composition and a resin that is reactive with the aniline oligomer, the catalyst being present at an effective amount to cure the coating composition at a temperature in the range from about 0° C. to about 40° C., or from about 0° C. to about 30° C., or at ambient temperature, or at room temperature.

Polyaniline may be used to provide corrosion-inhibiting coatings. However, significant issues are associated with the use of polyaniline, including its limited processability, low solubility, broad molecular weight distribution, and the presence of structural coating defects such as craters, pinholes, and the like, that often occur in coatings formed from polyaniline. The aniline oligomers employed with the invention, on the other hand, exhibit well-defined molecular structure, enhanced electroactivity and processability. The aniline oligomers of the invention may be used to impart anticorrosive properties to coating compositions.

In an embodiment, the aniline oligomer comprises an aniline trimer, tetramer, pentamer, hexamer, heptamer, octamer, nonamer, decamer, or a mixture of two or more thereof. The aniline oligomer may comprise a mixture of an aniline trimer and an aniline tetramer.

In an embodiment, the aniline oligomer comprises a compound represented by the formula:

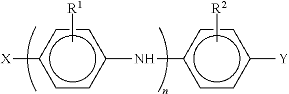

where X and Y independently comprise —NH₂, —H, —C₆H₄NH₂, —OC₆H₄NH₂, alkyl, aryl, —OH or —OR; R¹ and R² independently comprise —H, —OH, —COOH, alkyl, aryl, alkoxy, halogen, —NO₂, —NH₂, or —NHC₆H₄; at least one of X, Y, R¹ or R² is —NH₂; and n is a number in the range from 2 to about 20, or from 2 to about 10, or from 2 to about 5, or from 2 to about 3, or about 2.

In an embodiment, the aniline oligomer comprises the reaction product of 1,4-benzenediamine with an aniline oligomer.

In an embodiment, the aniline oligomer has a molecular weight in the range from about 100 to about 2000, or from about 200 to about 2000, or from about 280 to about 2000, or from about 280 to about 700, or from about 280 to about 400, or from about 280 to about 300.

In an embodiment, the aniline oligomer comprises N,N′-bis(4-aminophenyl)-1,4-quinonenediimine.

In an embodiment, the aniline oligomer is doped with an organic acid and/or a mineral acid. The aniline oligomer may be doped with salicylic acid, p-toluene sulfonic acid, methane sulfonic acid, citric acid, hydrochloric acid, phosphoric acid, sulfuric acid, or a mixture of two or more thereof. In an embodiment, the aniline oligomer may be doped with salicylic acid.

In an embodiment, the resin comprises an epoxy resin, a urethane resin, an acrylic resin, a polyimide resin, a urethane functionalized resin, a carboxylic acid functionalized resin, an anhydride functionalized resin, or a mixture of two or more thereof.

In an embodiment, the resin comprises an amine curable epoxy resin.

In an embodiment, the resin comprises Bisphenol A epoxy resin, Bisphenol F epoxy resin, Novolac epoxy resin, aliphatic epoxy resin, glycidylamine epoxy resin, or a mixture of two or more thereof.

In an embodiment, the catalyst comprises manganese nitrate, iron (III) nitrate, magnesium nitrate, zinc nitrate, magnesium perchlorate, calcium perchlorate, zinc perchlorate, cobalt perchlorate, a trifluoromethanesulfonic acid salt, boron trifluoride, methanol, ethylene glycol, glycerol, triethanolamine, phenol, bisphenol A, resorcinol, 4-bromothiophenol, 2-nitro-phenol, 3-nitro-phenol, 4-nitro-phenol, 2,4-dinitro-phenol, 2-chloro-phenol, 2,4-dichloro-phenol, 2,4,5-trichloro-phenol, 2,4,5,6-tetrachloro-phenol, p-chlororesorcinol, p-chlorophenol, p-bromophenol, octylphosphoric, toluenesulfonic, phenolsulfonic, benzenesulfonyl chloride, benzoic acid, thiobenzoic acid, m-hydroxy-benzoic acid, p-hydroxy-benzoic acid, 2,4-dihydroxy-benzoic acid, 2,5-dihydroxy-benzoic acid, 2-bromo-benzoic acid, 2-chloro-benzoic acid, 4-chloro-benzoic acid, 2,4-dichloro-benzoic acid, 2,4,5-trichloro-benzoic acid, salicylic acid, thiosalicylic acid, 2-methyl-benzoic acid, 2-mercapto-benzoic acid, 2-nitro-benzoic acid, 3,5-dinitro-benzoic acid, 2-chloro 5-nitro-benzoic acid, o-phthalic acid, m-phthalic acid, p-phthalic acid, trimellitic acid, lactic acid, propionic acid, succinic acid, triethylamine, tetramethylethylenediamine, benzene dimethylamine, 1-methyl imidazole, 2-methylimidazole, 2-ethyl-4-methyl imidazole, or a mixture of two or more thereof.

In an embodiment, the catalyst comprises salicylic acid, N-methylimidazole, benzyl alcohol, triethylene amine, or a mixture of two or more thereof.

In an embodiment, the composition further comprises an aliphatic amine. The aliphatic amine may comprise ethylenediamine, diethylene triamine, n-aminoethyl ethanolamine, hexamethylenediamine, trimethylhexamethylenediamine, diethylenetriamine, triethylenetriamine, tetraethylenepentamine, N,N-dimethylpropylenediamine, N,N-diethyl-1,3-propylenediamine, or a mixture of two or more thereof.

In an embodiment, the composition further comprises a cycloaliphatic amine. The cycloaliphatic amine may comprise 1,2-diaminocyclohexane, 1,3-diaminocyclohexanes, 1,4-diaminocyclohexane, 1,2-diamino-4-ethylcyclohexane, 1,3-bis(aminomethyl)cyclohexane, 1-4-bis(aminomethyl)cyclohexane, N-amino-ethylpiperazine, isophoronediamine, or a mixture of two or more thereof.

In an embodiment, the composition further comprises a solvent. The solvent may comprise acetonitrile, N-methylpyrolidone, N-ethyl pyrolidone, dimethylsulfoxide, dimethyl formamide, ethanolamine, benzyl alcohol, ethanol, methanol, isopropanol, acetone, ethyl acetate, butyl acetate, propyl acetate, ethylene glycol monobutyl ether, diethylene glycol, ethylene glycol, glycerin, diethylene glycol dimethyl ether, dimethyl ether, dimethyl formamide, formamide, methyl imidazole, tetrahydrofuran, methyl ethyl ketone, methyl t-butyl ether, pyridine, methylene chloride, pentane, hexanes, heptane, xylenes, toluene, or a mixture of two or more thereof.

In an embodiment, a polymer network is formed upon reacting the resin with the aniline oligomer.

In an embodiment, the composition is applied to a substrate at a wet film thickness of about 0.1 to about 100 mils.

In an embodiment, this invention relates to a coating composition, comprising: an aniline oligomer with at least one amine functional group; a resin that is reactive with the aniline oligomer; and an effective amount of a catalyst to cure the coating composition at a temperature in the range from about 0° C. to about 30° C.; wherein the catalyst comprises a cationic catalyst, anionic catalyst, imidazole, ketone, alcohol, tertiary amine, secondary amine, alkoxide, phenol, carboxylic acid, Lewis acid, carboxylic acid anhydride, sulfur containing compound, metal halide, a salt or complex of any of the foregoing catalysts, or a mixture of two or more of any of the foregoing.

In an embodiment, this invention relates to a coating composition comprising N,N′-bis(4-aminophenyl)-1,4-quinonenediimine; an epoxy resin; an amine crosslinker; and an effective amount of salicylic acid to cure the composition at a temperature in the range from about 0° C. to about 40° C., or from about 0° C. to about 30° C.

In an embodiment, this invention relates to a coating composition comprising: an aniline trimer; an epoxy resin; and a catalyst; wherein the catalyst is suitable for catalyzing a reaction between the aniline trimer and the epoxy resin at a temperature in the range from 0° C. to about 30° C. The catalyst may comprise a cationic catalyst, an anionic catalyst, imidazole, tertiary amine, secondary amine, alkoxide, phenol, carboxylic acid, Lewis acid, metal halide, or a combination of two or more thereof. The catalyst may comprise a nitrate of manganese, iron (III), magnesium, and/or zinc; a perchlorate of magnesium, calcium, zinc and/or cobalt; and/or a magnesium, ammonium, calcium, scandium and/or bismuth salt of trifluoromethanesulfonic acid, triethylamine, salicylic acid, or a combination of two or more thereof.

The aniline oligomers may be combined with resins that are reactive with the aniline oligomers (e.g., epoxy amine resin) to form coatings with improved anticorrosion properties. These coatings may cure at ambient or room temperature (e.g., about 0° C. to about 40° C., or about 0° C. to about 30° C.). The curing may be enhanced with the addition of one or more of the above-indicated catalysts. Aniline oligomers may react with epoxy resins or other resins commonly used in anticorrosion coatings. However, the reactivity of the aniline oligomers at ambient or room temperature tends to be relatively poor. Ambient or room temperature cure, on the other hand, is a required attribute for many coating applications. Amine-cured epoxy coatings that cure at ambient temperature are typically based upon aliphatic amines which are significantly more reactive than aromatic amines. Aniline oligomers, which are aromatic amines, typically do not cure effectively with epoxy resins at ambient temperatures. This invention allows the development of fully cured coating (e.g., epoxy-amine) compositions via the incorporation of an aniline oligomer and a catalyst with a resin that is reactive with the aniline oligomer. These compositions have the ability to cure at ambient temperature or room temperatures (e.g., from about 0° C. to about 40° C., or from about 0° C. to about 30° C.). This invention allows for the incorporation of aniline oligomers in a variety of coating compositions with the result being improved anticorrosion properties. The aniline oligomers, when combined with a polymer resin that is reactive with the aniline oligomer, may react with the resin in the presence of the catalyst and form part of the resulting polymer network.

In an embodiment, the invention relates to a metal substrate with any of the foregoing coating compositions applied to the metal substrate.

### BRIEF DESCRIPTION OF THE DRAWINGS

FIG. 1 is a spectra of the reaction of a commercially available epoxy resin (epoxide equivalent weight 370-410) with an aniline trimer (N,N′-bis(4-aminophenyl)-1,4-quinonenediimine) (1/1 weight ratio) at 0 hours, 2 days and 8 days at room temperature (no catalyst added).

FIG. 2 is a zoomed in spectra (zooming in the region of the epoxy group peak) of the reaction of a commercially available epoxy resin (epoxide equivalent weight 370-410) with an aniline trimer (N,N′-bis(4-aminophenyl)-1,4-quinonenediimine) (1/1 weight ratio) at 0 hours, 2 days and 8 days at room temperature (no catalyst added).

FIG. 3 is a spectra of the reaction of a commercially available epoxy resin (epoxide equivalent weight 370-410) with an aniline trimer (N,N′-bis(4-aminophenyl)-1,4-quinonenediimine) (1/1 weight ratio) after the addition of salicylic acid (5/1 mole ratio aniline trimer/salicylic acid) at 0 hours, 2 days and 7 days after mixing at room temperature.

FIG. 4 is a zoomed in spectra of the reaction of a commercially available epoxy resin (epoxide equivalent weight 370-410) with an aniline trimer (N,N′-bis(4-aminophenyl)-1,4-quinonenediimine) (1/1 weight ratio epoxy/aniline trimer) after the addition of salicylic acid (5/1 mole ratio aniline trimer/salicylic acid) at 0 hours, 2 days and 7 days after mixing at room temperature.

FIG. 5 is a spectra of the epoxy-amine reaction monitoring of a system containing Part A (epoxy resin, epoxide equivalent weight 370-410) and Part B (amine hardener, active amine hydrogen equivalent weight 150-180) of a commercially available epoxy-amine coating and an aniline trimer (N,N′-bis(4-aminophenyl)-1,4-quinonenediimine) (Part A/Part B/aniline trimer weight ratio 6.6/1/2) in the absence of salicylic acid at 0 hours, 2 days and at 7 days after mixing at room temperature.

FIG. 6 is a zoomed in spectra (zooming in the region of the epoxy group peak) of the epoxy-amine reaction monitoring of the system containing Part A (epoxy resin, epoxide equivalent weight 370-410) and Part B (amine hardener, active amine hydrogen equivalent weight 150-180) of a commercially available epoxy-amine coating and an aniline trimer (N,N′-bis(4-aminophenyl)-1,4-quinonenediimine) (Part A/Part B/aniline trimer weight ratio 6.6/1/2) in the absence of salicylic acid at 0 hours, 2 days and 7 days after mixing at room temperature.

FIG. 7 is a zoomed in spectra (zooming in the region of the epoxy group peak) of the epoxy-amine reaction monitoring of a system containing Part A (epoxy resin, epoxide equivalent weight 370-410) and Part B (amine hardener, active amine hydrogen equivalent weight 150-180) of a commercially available epoxy-amine coating and an aniline trimer (N,N′-bis(4-aminophenyl)-1,4-quinonenediimine) (Part A/Part B/aniline trimer weight ratio 6.6/1/2) in the presence of salicylic acid (5/1 mole ratio of aniline trimer to salicylic acid) at 0 hours and at 7 days after mixing at room temperature.

### DETAILED DESCRIPTION

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural. All combinations specified in the claims may be combined in any manner.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The word “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or may refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

The phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The term “aniline oligomer” refers to a compound containing from about 2 to 20 repeat units of aniline or substituted aniline.

The term “polyaniline” refers to a polymer containing more than 20 aniline or substituted aniline repeat units.

The aniline oligomer may comprise an aniline trimer, tetramer, pentamer, hexamer, heptamer, octamer, nonamer, decamer, or a mixture of two or more thereof. The aniline oligomer may comprise a mixture of an aniline trimer and an aniline tetramer. The aniline oligomer may comprise N,N′-bis(4-aminophenyl)-1,4-quinonenediimine. The aniline oligomer may be a compound represented by the formula:

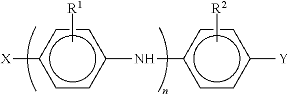

where X and Y independently comprise —NH₂, —H, —C₆H₄NH₂, —OC₆H₄NH₂, alkyl, aryl, —OH or —OR; R¹ and R² independently comprise —H, —OH, —COOH, alkyl, aryl, alkoxy, halogen, —NO₂, —NH₂, or —NHC₆H₄; at least one of X, Y, R¹ or R² is —NH₂; and n is a number in the range from 2 to about 20, or from 2 to about 10, or from 2 to about 5, or from 2 to about 3, or about 2. The aniline oligomer may comprise the reaction product of 1,4-benzenediamine with an aniline oligomer. The aniline oligomer may have a molecular weight in the range from about 100 to about 2000, or about 200 to about 2000, or about 280 to about 2000, or from about 280 to about 700, or from about 280 to about 400, or from about 280 to about 300.

The aniline oligomer may be doped with an organic acid and/or a mineral acid. The acid may comprise salicylic acid, p-toluene sulfonic acid, methane sulfonic acid, citric acid, hydrochloric acid, phosphoric acid, sulfuric acid, or a mixture of two or more thereof. The weight ratio of the aniline oligomer to the doping acid may be in the range from about 10 to about 1, or from about 5 to about 1.

The aniline oligomer may acquire any of the available oxidation states. These may include the leucoemeraldine form, which is a fully reduced state; or the emeraldine form, which is a neutral state; or the pernigraniline form which is a fully oxidized state. The different oxidation states may be represented by the following formula:

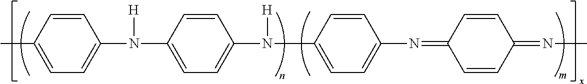

where n=1 and m=0 for the fully reduced leucoemeraldine state, where n=0.5 and m=0.5 for the neutral emeraldine state, where n=0 and m=1 for the fully oxidized pernigraniline state. The different oxidation states of an aniline trimer may be represented by the following formulas:

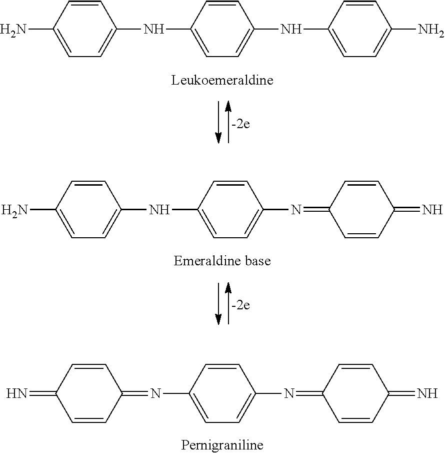 [SMILES: Nc1ccc(Nc2ccc(Nc3ccc(N)cc3)cc2)cc1 ; N=C1C=CC(=Nc2ccc(Nc3ccc(N)cc3)cc2)C=C1 ; N=C1C=CC(=Nc2ccc(N=C3C=CC(=N)C=C3)cc2)C=C1]

The corrosion resistant additive composition and/or the coating composition may comprise an effective amount of an oxidizing agent to oxidize and maintain the aniline oligomer in a desired oxidation state, for example, the pernigraniline form. The oxidizing agent may comprise any compound that contains an oxygen-oxygen single bond, a peroxide group or a peroxide ion. Examples may include hydrogen peroxide; organic peroxides such as peroxy acids, peroxy carboxylic acid, and cummene hydroperoxide; inorganic peroxides such peroxide salts, alkali or alkaline earth metal peroxides; acid peroxides such as peroxy monosulfuric acid and peroxy disulfuric acid. The oxidizing agent may comprise persulfates such as potassium, sodium and/or ammonium persulfate, ammonium peroxydisulfate; perchlorates such as potassium perchlorate; iodinated salts such as potassium iodinate; halogenated metal acids such as chlorolaurate acid; azo-initiators such as azobisisobutyronitrile, azobiscyanovaleriane acid and 2,2′-azobis(2-methylpropion-amidin)dihydrochloride; redox initiator systems including oxidizers such as t-butyl hydroxide, t-butyl peroxide, cumol hydroperoxide, t-butyl peroxopivalate, isopropyl benzomonohydroperoxide, dibenzoyl peroxide, dicumylperoxide, alkyl hydroperoxide, bicyclohexylperoxydicarbonate and dicetylperoxydicarbonate, potassium dichromate, sodium dichromate, ammonium dichromate, ferric sulfonate, cupric sulfonate, and lead oxide. Mixtures of two or more of the foregoing may be used.

The corrosion resistant additive composition and/or the coating composition may comprise an effective amount of a reducing agent to reduce the aniline oligomer and maintain the aniline oligomer in a desired reduced state, for example, the leucoemeraldine form. The reducing agent may comprise any element or compound that donates an electron to another species. The reducing agent may comprise any compound that donates hydrogen to a molecule. Examples may include atomic hydrogen, hydrazine, sodium borohydride, lithium aluminum hydride, sodium amalgam, diborane, tin (II) chloride, sulfite compounds, zinc-mercury amalgam, diisobutylaluminum hydride, oxalic acid, formic acid, ascorbic acid, phosphites, hypophopshites, phosphorous acid, iron (II) sulfate, carbon monoxide, carbon, or a mixture of two or more thereof.

The catalyst may comprise one or more catalysts, such as various cationic and anionic catalysts, imidazoles, tertiary amines, secondary amines, alkoxides, phenols, carboxylic acids, carboxylic acid anhydrides, sulfur containing compounds, Lewis acids, metal halides, or a mixture of two or more thereof.

These may include nitrates of manganese, iron (III), magnesium and zinc, perchlorates of magnesium; calcium; zinc; and cobalt; salts of trifluoromethanesulfonic acid such as magnesium; ammonium; calcium; scandium and bismuth; boron trifluoride; methanol; ethylene glycol; glycerol; triethanolamine; phenol, bisphenol A; resorcinol; 4-bromothiophenol; 2-nitro-phenol; 3-nitro-phenol; 4-nitro-phenol; 2,4-dinitro-phenol; 2-chloro-phenol; 2,4-dichloro-phenol; 2,4,5-trichloro-phenol; 2,4,5,6-tetrachloro-phenol; p-chlororesorcinol; p-chlorophenol; p-bromophenol; octylphosphoric; toluenesulfonic; phenolsulfonic; benzenesulfonyl chloride; benzoic acid; thiobenzoic acid; m-hydroxy-benzoic acid; p-hydroxy-benzoic acid; 2,4-dihydroxy-benzoic acid; 2,5-dihydroxy-benzoic acid; 2-bromo-benzoic acid; 2-chloro-benzoic acid; 4-chloro-benzoic acid; 2,4-dichloro-benzoic acid; 2,4,5-trichloro-benzoic acid; salicylic acid; thiosalicylic acid; 2-methyl-benzoic acid; 2-mercapto-benzoic acid; 2-nitro-benzoic acid; 3,5-dinitro-benzoic acid; 2-chloro 5-nitro-benzoic acid; o-phthalic acid; m-phthalic acid; p-phthalic acid; trimellitic acid; lactic acid; propionic acid; succinic acid; triethylamine; tetramethylethylenediamine; benzene dimethylamine; 1-methyl imidazole; or combinations thereof.

The weight ratio of the aniline oligomer to the catalyst may be in the range from about 20 to about 5, or from about 15 to about 10.

The combination of the aniline oligomer and the catalyst may be provided as a corrosion resistant additive composition which may be combined with a resin that is reactive with the aniline oligomer to form a corrosion resistant coating composition which may be curable at room temperature or ambient temperature, for example, at a temperature in the range from about 0° C. to about 40° C., or about 0° C. to about 30° C. The concentration of the aniline oligomer in the coating composition may be in the range from about 10 to about 1% by weight, or from about 8 to about 4% by weight. The concentration of the catalyst in the coating composition may be in the range from about 1 to about 0.1% by weight, or from about 0.6 to about 0.2% by weight. The concentration of the resin in the coating composition may be in the range from about 80 to about 20% by weight, or from about 80 to about 40% by weight.

The resin may comprise an epoxy resin, a urethane resin, an acrylic resin, a polyimide resin, a urethane functionalized resin, a carboxylic acid functionalized resin, an anhydride functionalized resin, or a mixture of two or more thereof. The epoxy resin may comprise any polymer or prepolymer that typically contains at least two epoxide groups. The epoxide groups may be referred to as glycidyl or oxirane groups. The epoxy resin may be reacted (or crosslinked) with the aniline oligomer. The reaction may be referred to as a hardening or curing reaction. The reaction may occur at a temperature in the range from about 0° C. to about 40° C., or about 0° C. to about 30° C., or ambient or room temperature. The epoxy resin may be formed by reacting epichorohydrin with a bisphenol A to form a diglycidyl ether of bisphenol A. For example, two moles of epichorohydrin may be reacted with one mole of bisphenol A to form bisphenol A diglycidyl ether (which may be referred to as DGEBA or BADGE). The epoxy resin may be a bisphenol F epoxy resin wherein bisphenol F may be epoxidized in a similar manner to bisphenol A. The epoxy resin may be a Novolac resin wherein a phenol is reacted with formaldehyde followed by glycidylation with epichorohydrin. Examples may include epoxy phenol novolacs and epoxy cresol novolacs. The epoxy resin may be an aliphatic epoxy resin. These may include glycidyl epoxy resins and cycloaliphatic epoxides. The epoxy resin may be a glycidylamine epoxy resin wherein the resin is formed when an aromatic amine is reacted with epichorolydrin. Examples may include trigylcidyl-p-aminophenol and N,N,N,N-tetraglicidyl-4,4-methylenebis benzylamine.

The polyurethane resin may comprise a polymer chain of organic units joined by carbamate (urethane) links. The polyurethane resin may be formed by the reaction of an isocyanate with a polyol. The polyurethane resin may be referred to as a urethane. The isocyanates may include aromatic isocyanates such as diphenylmethane diisocyanate (MDI) and toluenediisocyanate (TDI), and aliphatic isocyanates such as hexamethylene diisocyanate (HDI) and isophorone diisocyanate (IPDI). The polyols may include polyether polyols and polyester polyols.

The acrylic resins may be resins derived from acrylic acid or methacrylic acid, or other related compounds. These may be referred to as polyacrylates, polymethylacrylates, and polymethylmethacrylates.

The polyimides may be polymers derived from one or more imide monomers. The imide monomers may include pyromellitic dianhydride and 4,4′-oxydianiline. The polyimides may be aliphatic or aromatic. The polyamides may be prepared by the reaction of a dianhydride with a diamine or a diisocyanate. The dianhydrides may include pyromellitic dianhydride and naphthalene tetracarboxylic dianhydride.

The corrosion resistant additive composition and/or the coating composition may comprise one or more aliphatic amines. These may include ethylenediamine, diethylene triamine, n-aminoethyl ethanolamine, hexamethylenediamine, trimethylhexamethylenediamine, diethylenetriamine, triethylenetriamine, tetraethylenepentamine, N,N-dimethylpropylenediamine, N,N-diethylpropylenediamine-1,3, or a mixture of two or more thereof. The concentration of the aliphatic amines in the corrosion resistant additive composition, when present, may be in the range from about 90 to about 5% by weight, or from about 90 to about 50% by weight. The concentration of the aliphatic amines in the coating composition, when present, may be in the range from about 80 to about 5% by weight, or from about 50 to about 5% by weight.

The corrosion resistant additive composition and/or the coating composition may comprise one or more cycloaliphatic amines. These may include 1,2-diaminocyclohexane, 1,3-diaminocyclohexanes, 1,4-diaminocyclohexane, 1,2-diamino-4-ethylcyclohexane, 1,3-bis(aminomethyl)cyclohexane, 1-4-bis(aminomethyl)cyclohexane, N-amino-ethylpiperazine, isophoronediamine, or a mixture of two or more thereof. The concentration of the cycloaliphatic amines in the corrosion resistant additive composition, when present, may be in the range from about 90 to about 5% by weight, or from about 90 to about 50% by weight. The concentration of the cycloaliphatic amines in the coating composition, when present, may be in the range from about 80 to about 5% by weight, or from about 50 to about 5% by weight.

The corrosion resistant additive composition and/or the coating composition may comprise one or more solvents. These may cinlude acetonitrile, n-methyl pyrolidone, n-ethyl pyrolidone, dimethylsulfoxide, dimethyl formamide, ethanolamine, benzyl alcohol, ethanol, methanol, isopropanol, acetone, ethyl acetate, butyl acetate, propyl acetate, ethylene glycol monobutyl ether, diethylene glycol, ethylene glycol, glycerin, diethylene glycol dimethyl ether, dimethyl ether, dimethyl formamide, formamide, methyl imidazole, tetrahydrofuran, methyl ethyl ketone, methyl t-butyl ether, pyridine, methylene chloride, pentane, hexanes, heptane, xylenes, toluene, or a mixture of two or more thereof. The concentration of the solvent in the corrosion resistant additive composition, when present, may be in the range from about 30 to about 1% by weight, or from about 20 to about 1% by weight. The concentration of the solvent in the coating composition may be in the range from about 20 to about 1% by weight, or from about 10 to about 1% by weight.

Amine-cured epoxy resins are two-component coatings systems, where both components may be blended onsite and used over the course of a limited timeframe (pot life), usually on the order of hours. These systems typically employ the use of aromatic amines. These compositions typically require high curing temperatures (e.g., 80° C. and higher) for curing the polymer network. On the other hand, ambient or room temperature cure is a required feature for many coating applications. Amine-cured epoxy coatings that cure at ambient or room temperature are typically based on aliphatic amines which are more reactive than aromatic amines. Aniline oligomers, which are aromatic amines, typically do not fully cure with epoxy resins at ambient temperatures. Poor cure results in poor physical properties for the resulting coating. This invention allows for the development of fully cured epoxy-amine compositions via the incorporation of aniline oligomers and one or more catalysts for enhancing the reaction between the aniline oligomer and the resin. These compositions have the ability to cure at ambient or room temperatures (e.g., from about 0° C. to about 40° C., or from 0° C. to about 30° C.) to provide fully cured coating compositions.

Aniline oligomers may react with the polymer resins to become part of the polymer network at ambient or room temperature when the catalysts of the invention are present.

The amine equivalent weight of the aniline oligomers may be in the range from about 400 to about 50, or from about 150 to about 50. The amine equivalent weight of the aniline oligomer may be the weight of the oligomer that corresponds to one amine hydrogen that is available for reaction with a polymer resin, e.g., an epoxy resin. Equivalent weights may allow, for example, for the determination of the relative amounts of the epoxy and the amine parts needed to perform stoichiometric (equal number of epoxy groups and amine groups) reactions (curing/crosslinking) between the epoxies and amines. For example, an aniline trimer may react with an epoxy group via four potential sites; two primary aromatic amine hydrogens on each side of aniline trimer may be available for reaction with an epoxy. However, after the first hydrogen of the primary amine reacts, the second hydrogen may then become a secondary aromatic amine which has a lower reactivity. Anticorrosion additive compositions may be formulated with aniline trimers by considering both two and four active amine hydrogens of each trimer molecule (1 and 2 on each side of the aniline trimer structure respectively). These two methods for calculating the amine equivalent weight of aniline trimer will indicate different amounts of the aniline trimer required for the final coating composition.

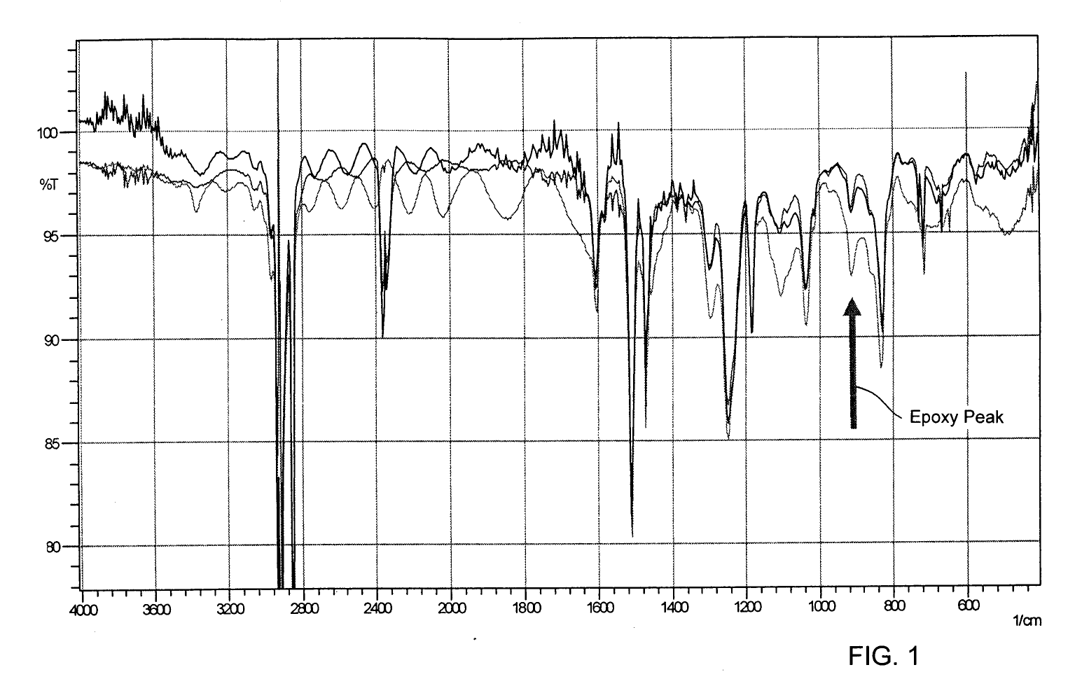

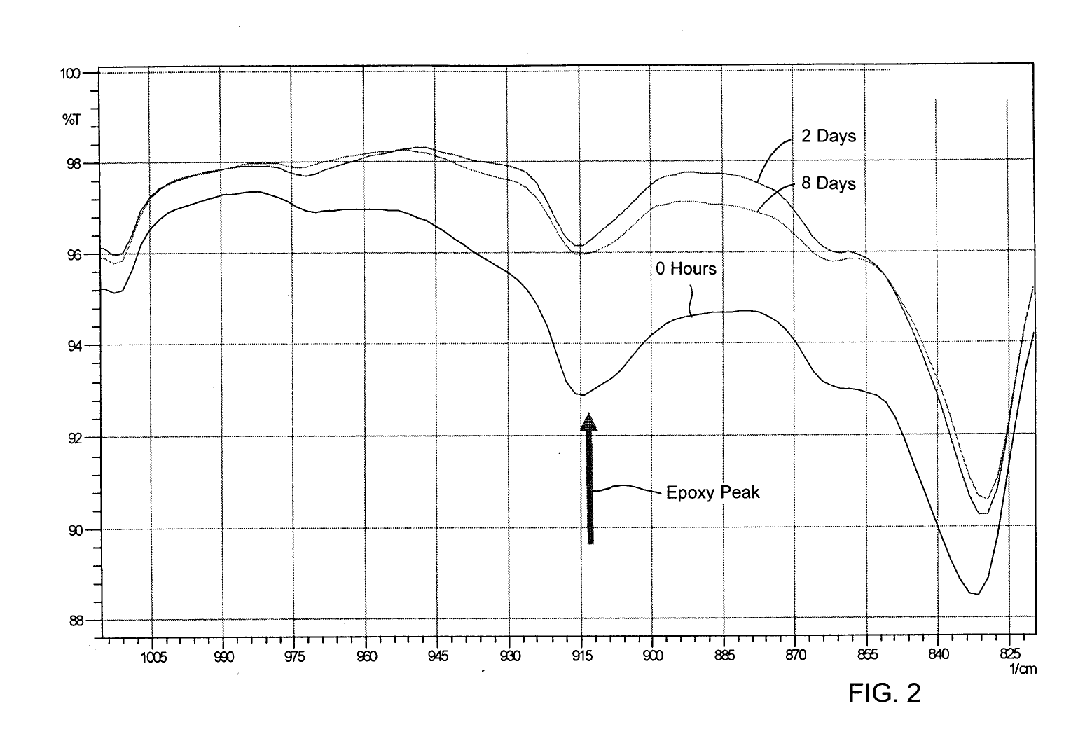

Aniline trimers may react with epoxy resins in the presence of one or more of the above-identified catalysts, e.g., salicylic acid. Infrared spectroscopy may be utilized to determine the reactivity of the aniline trimer with epoxy resins. FIGS. 1 and 2 show the IR spectra of the reaction of a commercially available epoxy resin (epoxide equivalent weight 370-410) and amine functional aniline trimer (1/1 weight ratio) at 0 hrs, two days and at 7 days after mixing without the addition of catalyst. The characteristic epoxy peak at 915 cm⁻¹ is prominent at 0 hrs and it remains prominent even after 7 days of reaction indicating that the reaction of the epoxy groups with the aromatic amine groups of aniline trimer is not complete after 7 days when no catalyst is used.

This indicates that the reaction of the aniline oligomers with epoxy resin is very slow at room temperature. Ambient or room temperature cure, on the other hand, is a required feature for many general maintenance coating applications, for example, in many military and industrial end-uses, including recoating bilges of maritime vessels. Amine-cured epoxy coatings that cure at room or ambient temperatures are typically based on aliphatic amines which are significantly more reactive than aromatic amines (e.g., aniline oligomers). The compositions of this invention comprise the addition of a catalyst that can facilitate the reaction of aniline oligomers and polymer resins, such as epoxies, at ambient or room temperatures to drive the reaction between the resin and the aniline oligomer to completion.

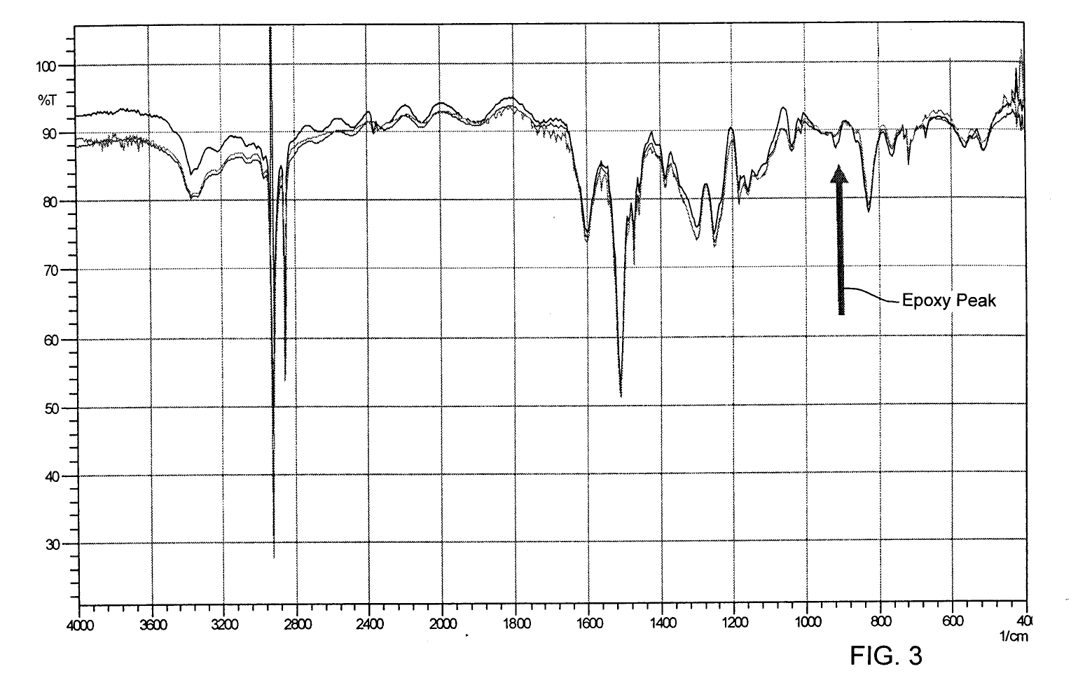

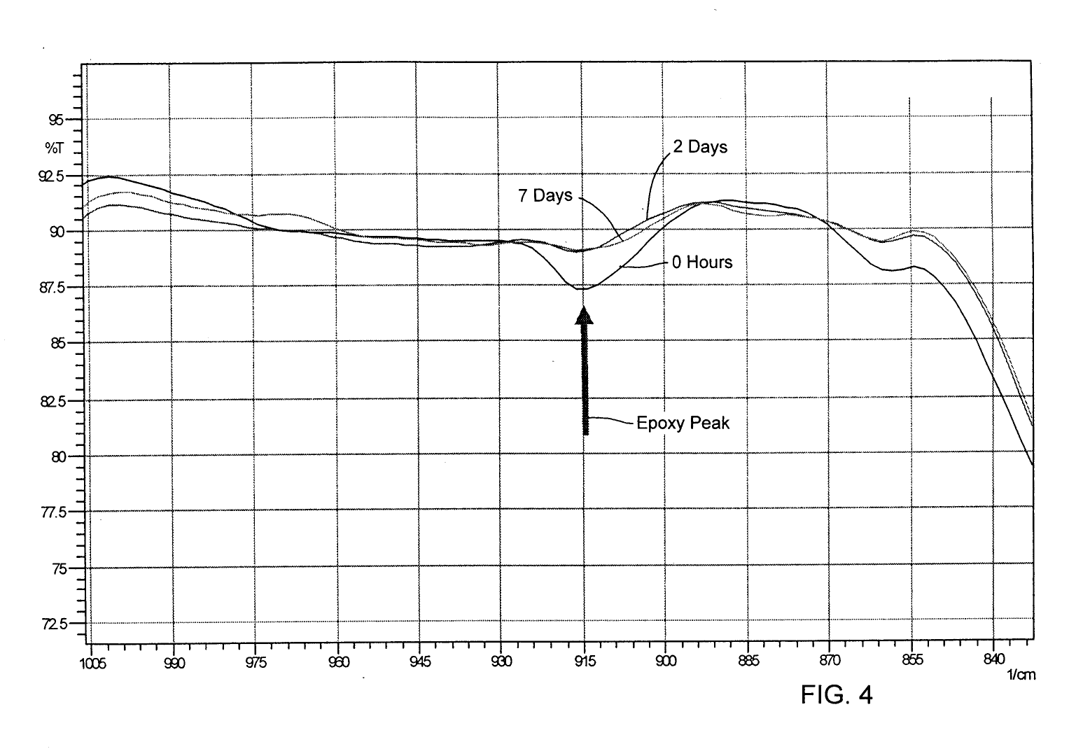

Evaluation of the capacity of various catalysts to catalyze the reaction of aniline trimer with a commercially available epoxy resin (epoxide equivalent weight 370-410) is performed by monitoring the reaction of amine functional aniline trimer with epoxies after the addition of salicylic acid which functions as a catalyst (5/1 mole ratio catalyst/aniline trimer). These evaluations indicate that salicylic acid efficiently catalyzes the reaction of aniline trimer with the epoxy groups of the epoxy resin. FIGS. 3 and 4 show the IR spectra of the reaction of the epoxy resin with the aniline trimer after the addition of salicylic acid (5/1 mole ratio aniline trimer/salicylic acid) at 0 hrs, 2 days and at 7 days after mixing at room temperature. The characteristic epoxy peak at 915 cm⁻¹ is evident at 0 hrs and is almost exhausted after two days indicating almost complete reaction of the epoxy groups of the resin with the amine groups of the aniline trimer in the presence of salicylic acid as the catalyst.

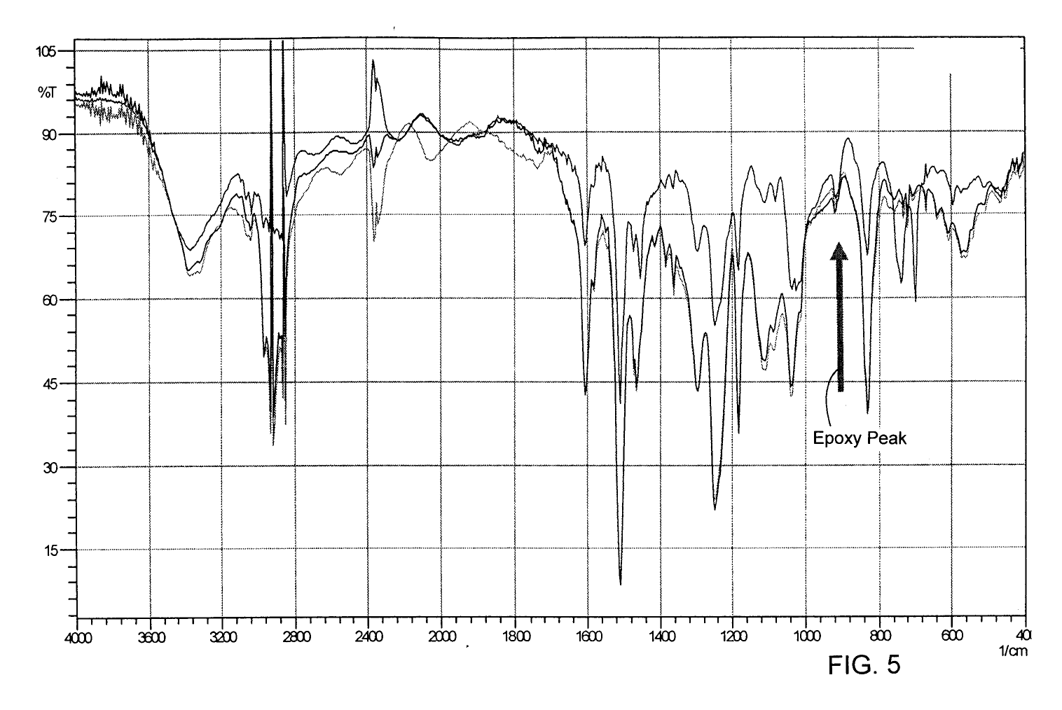

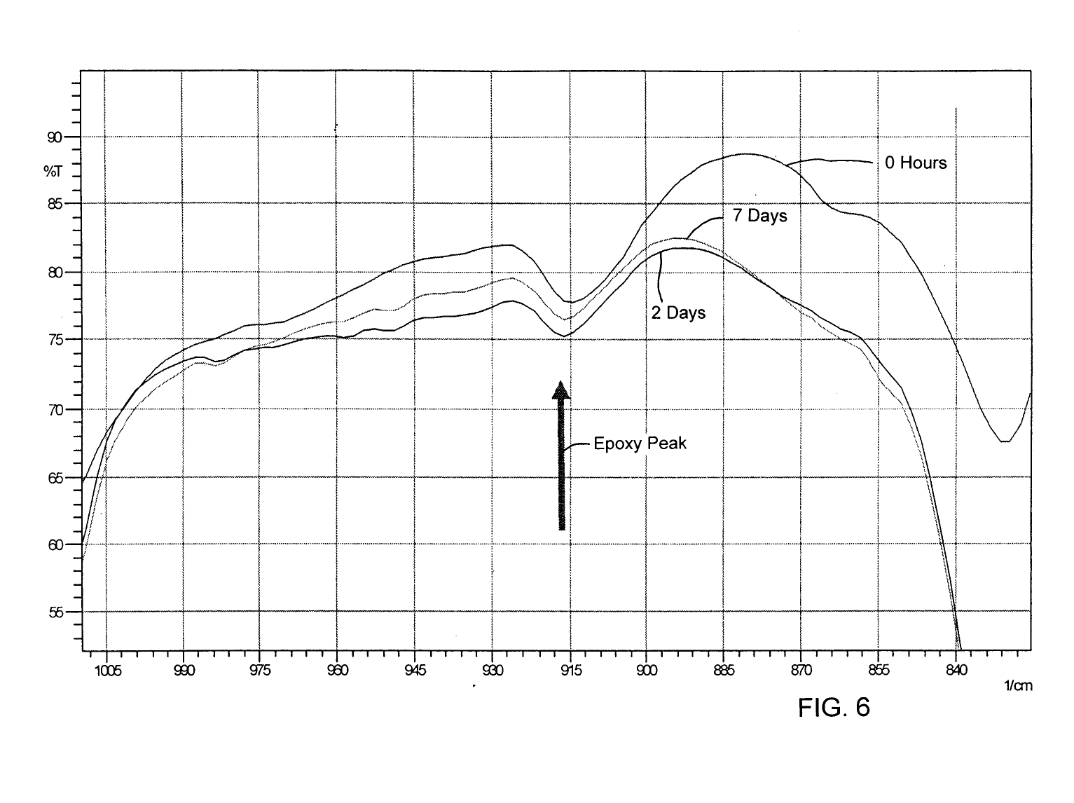

This catalytic system is evaluated in the presence of solvents, co-solvents and various loadings of aniline oligomers. FIGS. 5 and 6 show the reaction of Part A (epoxy resin, epoxide equivalent weight 370-410) with Part B (amine hardener, active amine hydrogen equivalent weight 150-180) of a commercially available epoxy resin when Part B is replaced by the aniline trimer (Part B/aniline trimer weight ratio 1/2) in the absence of salicylic acid (catalyst) at 0 hrs, at 2 days and at 7 days after mixing. Benzyl alcohol is used as a co-solvent in this system. The characteristic epoxy peak at 915 cm⁻¹ is prominent at 0 hrs and it remains prominent after 7 days of reaction when no catalyst is added. Epoxy groups are still detectable via IR even 12 days after mixing, which indicates that the reaction of the epoxy groups of part A with the amine groups of part B and the aniline trimer is not complete (epoxy groups have not been exhausted) when no catalyst is incorporated in the system.

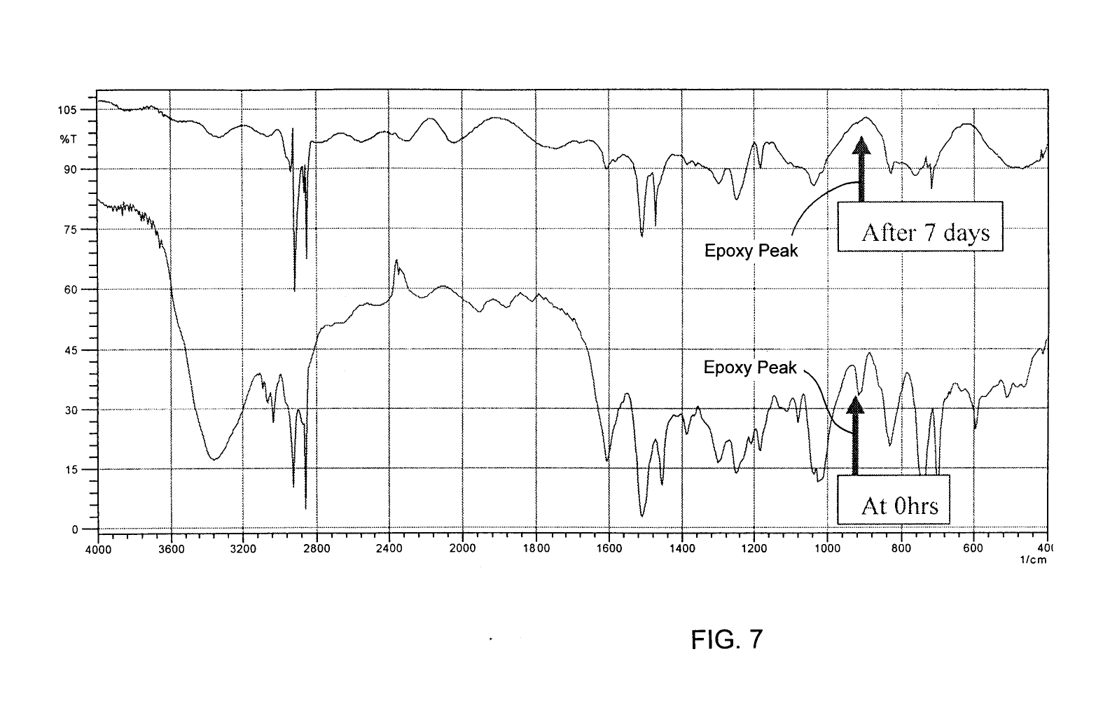

FIG. 7 shows the reaction of Part A (epoxy resin, epoxide equivalent weight 370-410) with Part B (amine hardener, active amine hydrogen equivalent weight 150-180) of a commercially available epoxy amine coating when Part B is replaced by the aniline trimer (Part B/aniline trimer weight ratio 1/2) in the presence of salicylic acid (5/1 mole ratio aniline trimer/salicylic acid) at 0 hrs and at 7 days after mixing. As shown in these spectra, the characteristic epoxy peak at 915 cm⁻¹ is prominent at 0 hrs has been exhausted after 7 days. This indicates the complete reaction of the epoxy groups of part A with the amine groups of part B and the aniline trimer after 7 days when salicylic acid is incorporated in the system.

These results indicate that salicylic acid allows the complete reaction of aniline trimer with epoxies and the complete curing of the final coating at ambient temperature, resulting in a fully crosslinked network and full incorporation of the aniline oligomer into the polymer network. These compositions show improved anticorrosion performance when applied to cold-rolled steel panels and subjected to accelerated corrosion tests compared to compositions that do not contain the aniline trimer. The invention allows the incorporation of aniline oligomers in a variety of epoxy amine coatings and their curing at ambient or room temperatures. These compositions exhibit improved corrosion resistance with no deterioration of the mechanical properties of the final coatings compared to compositions that do not contain the aniline trimer.

The corrosion resistant additive compositions of the invention may be incorporated into a wide variety of coating compositions to impart improved corrosion resistance. These may include top-coats, primers, latexes, epoxies, acrylics, polyurethanes, polyimides, and the like.

### Example 1

N,N′-bis-(4-aminophenyl)-1,4-quinonenediimine, which may be referred to as an aniline trimer, is added to Interbond 998 (a U.S. Navy approved general maintenance two-party epoxy coating composition with Part A being an epoxy resin (epoxide equivalent weight of 370-410) and Part B being an amine crosslinker (active amine hydrogen equivalent weight of 150-180). The final composition contains 0.3% by weight of the aniline trmer, 66.5% by weight of Part A and 33.2% by weight of Part B. Parts A and B are mixed before use. The resulting coating composition may be referred as Formulation A. Formulation A can be used to protect metal surfaces from corrosion.

### Example 2

The aniline trimer identified in Example 1 is added to Interbond 998 (0.3% by weight aniline trimer in the final composition). The resulting coating composition comprises Part A (65.3% by weight in the final composition) and Part B (32.7% by weight in the final composition). Parts A and B are mixed before use. Methyl imidazole is added to the above composition at a concentration of 1.7% (by weight in final composition). The resulting coating composition may be referred as Formulation B. Formulation B can be used to protect metal surfaces from corrosion.

### Example 3

The aniline trimer identified in Example 1 is added to Interbond 998 (1.6% weight aniline trimer in the final composition). The coating composition comprises Part A (63.4% by weight in the final composition) and Part B (31.7% by weight in the final composition). Parts A and B are mixed before use. Methyl imidazole is added to the above composition at a concentration of 3.3% (by weight in final composition). The resulting coating composition may be referred as Formulation C. Formulation C can be used to protect metal surfaces from corrosion.

### Example 4

Formulations A, B and C are used to coat cold rolled steel panels and their anticorrosion performance is compared to Interbond 998 (control coating). Rating of the anticorrosion capacity of the formulations is performed according to ASTM standard D1654-08, “Standard test method for evaluation of painted or coated specimens subjected to corrosive environments”. The coated specimens are initially scribed with a scribing tool (v shape) until penetration through to the bare metal substrate. After exposure of the test specimens to accelerated corrosion testing (according to ASTM B117, “Standard practice for operating salt spray (fog) apparatus”), rating of the corrosion performance is performed by removing the coating along the scribe (by mechanical means with a spatula or a blade) and by measuring the distance corrosion has traveled away from the original scribe. The results are shown in Tables 1 and 2. Note that the higher the rust creepage rating number in Tables 1 and 2, the better the anticorrosion performance of the coating.

TABLE 1
Rust creepage rating of cold rolled steel panels using Formulations
A, B and C and Interbond 998 (control):

| | | | | | Duration in | |
|---|---|---|---|---|---|---|
| | Aniline | Methyl | Wet film | Dry Film | Salt Fog | Rust |
| | trimer | Imidazole | Thickness | Thickness | Chamber | Creepage |
| Formulation¹ | (wt %)² | (wt %)² | (mils)³ | (mils)⁴ | (hrs) | Rating⁵ |
| Interbond 998 | 0.00 | 0 | 7 | 4.6 | 1104 | 7 |
| | | | 11 | 6.9 | | 6 |
| Formulation A | 0.3 | 0 | 7 | 4.4 | 1080 | 8 |
| | | | 11 | 7 | | 7 |
| Formulation B | 0.3 | 1.7 | 7 | 4.7 | 1080 | 8 |
| | | | 11 | 7.1 | | 7 |
| Formulation C | 1.6 | 3.3 | 7 | 4.8 | 1080 | 8 |
| | | | 11 | 7.2 | | 7 |

¹Each formulation is applied in triplicate.
²Based on the total weight of the final formulation.
³Measured with a wet film gauge (calling card type) from Gardco; Paul N. Gardner Company, Inc., FL.
⁴Average dry film thickness of three panels; Dry film thickness of coatings is measured with a coating thickness gage (Positector 6000, DeFelsko, NY).
⁵Average rating of three replicates according to ASTM D1654-08 for evaluation of painted or coated specimens subjected to corrosive environments; the higher the number the better the anticorrosion performance.

TABLE 2
Rust creepage rating of cold rolled steel panels using Formulations B and C
and Interbond 998 (control):

| | Aniline | Methyl | Wet film | Dry Film | Duration in Salt | Rust |
|---|---|---|---|---|---|---|
| | trimer | Imidazole | Thickness | Thickness | Fog Chamber | Creepage |
| Formulation¹ | (wt %)² | (wt %)² | (mils)³ | (mils)⁴ | (hrs) | Rating⁵ |
| Interbond 998 | 0.0 | 0 | 2 | 0.99 | 720 | 6 |
| | | | 3 | 1.71 | | 6 |
| | | | 6 | 4.05 | | 7 |
| Formulation B | 0.3 | 1.6 | 2 | 0.75 | 720 | 7 |
| | | | 3 | 1.72 | | 8 |
| | | | 6 | 4 | | 8 |
| Formulation C | 1.6 | 3.3 | 2 | 0.74 | 720 | 8 |
| | | | 3 | 1.89 | | 8 |
| | | | 6 | 4.13 | | 8 |

¹Each formulation is applied in triplicate.
²Based on the total weight of the final formulation.
³Measured with a wet film gauge (calling card type) from Gardco; Paul N. Gardner Company, Inc., FL.
⁴Average dry film thickness of three panels; Dry film thickness of coatings is measured with a coating thickness gage (Positector 6000, DeFelsko, NY).
⁵Average rating of three replicates according to ASTM D1654-08 for evaluation of painted or coated specimens subjected to corrosive environments; the higher the number the better the anticorrosion performance.

### Example 5

The aniline trimer identified in Example 1 is added to Interbond 998 (0.3% by weight aniline trimer in the final composition). The resulting coating composition comprises Part A (65.8% by weight in final composition) and Part B (32.9% by weight in final composition). Parts A and B are mixed before use. Benzyl alcohol is added to the above composition at a concentration of 1% (by weight in final composition). The resulting coating composition may be referred as Formulation D.

Formulation D can be used to protect metal surfaces from corrosion.

### Example 6

The aniline trimer identified in Example 1 is added to Interbond 998 (2.6% by weight of the aniline trimer in the final composition). The resulting coating composition comprises Part A (62.5% by weight in final composition) and Part B (31.3% by weight in final composition). Parts A and B are mixed before use. Benzyl alcohol is added to the above composition at a concentration of 3.3% (by weight in final composition). Methyl imidazole is added to the above composition at a concentration of 0.3% (by weight in final composition). The resulting coating composition may be referred as Formulation E. Formulation E can be used to protect metal surfaces from corrosion.

### Example 7

The aniline trimer identified in Example 1 is added to Interbond 998 (0.3% by weight coating composition in the final composition). The resulting coating composition comprises Part A (65.8% by weight in final composition) and Part B (32.9% by weight in final composition). Parts A and B are mixed before use. Methyl imidazole is added to the above composition at a concentration of 1% (by weight in final composition). The resulting coating composition may be referred as Formulation F. Formulation F can be used to protect metal surfaces from corrosion.

### Example 8

The aniline trimer identified in Example 1 is added to Interbond 998 (2.6% by weight of the aniline trimer in the final composition). The resulting coating composition comprises Part A (62.7% by weight in final composition) and Part B (31.4% by weight in final composition). Parts A and B are mixed before use. Methyl imidazole is added to the above composition at a concentration of 3.3% (by weight in final composition). The resulting coating composition may be referred as Formulation G. Formulation G can be used to protect metal surfaces from corrosion.

### Example 9

The aniline trimer identified in Example 1 is added to Interbond 998 (2.6% by weight of the aniline trimer in the final composition). The resulting coating composition comprises Part A (64.9% by weight in final composition) and Part B (32.5% by weight in final composition). Parts A and B are mixed before use. The resulting coating composition may be referred as Formulation H. Formulation H can be used to protect metal surfaces from corrosion.

### Example 10

Formulations D, E, F, G and H are used to coat cold rolled steel panels and their anticorrosion performance is compared to Interbond 998 (control coating). The rating of the degree of blistering of the formulations subjected to accelerated corrosion is performed according to ASTM D714-02 “Standard test method for evaluating degree of blistering of paints” where the size of the blisters on the coating is expressed on a numerical scale from 10 to 0, in which 10 represents no blistering and 9 represents the smallest size of blister easily seen by the unaided eye. Rating values of 8, 7, 6, down to 1 correspond to progressively larger blister sizes. The frequency of the blisters shown on a coating are designated with the letters D, MD, M, and F which correspond to dense, medium dense, medium, and few respectively. For example a coating that shows many medium-size blisters would get a rating of 5MD (5-Medium Dense) whereas a panel that shows a few tiny blisters would get a rating of 9F (9-Few). All of the formulations evaluated during this study are run in triplicates. The results are shown in Table 3.

TABLE 3
Rating of the degree of blistering of cold rolled steel panels coated
with Formulations D, E, F, G, H and Interbond 998 (control) after 600 hours in a salt
fog chamber

| | Aniline | Benzyl | Methyl | Wet film | Dry Film | Degree of Blistering |
|---|---|---|---|---|---|---|
| | trimer | Alcohol | Imidazole | Thickness | Thickness | after 600 hrs in |
| Formulation¹ | (wt %)² | (wt %)² | (wt %)² | (mils)³ | (mils)⁴ | Corrosion Chamber⁵ |
| Interbond 998 | 0.0 | 0 | 0 | 3 | 1.98 | 6 D, 7 MD, 4 MD |
| | | | | 6 | 4.47 | 5 F, 4 F, 6 M |
| Formulation D | 0.3 | 1.0 | 0 | 3 | 2.11 | 8 M, 8 MD, 9 M |
| | | | | 6 | 4.26 | 8 F, 8 F, 4 M |
| Formulation E | 2.6 | 3.3 | 0.3 | 3 | 2.1 | 8 MD, 8 M, 7 M |
| | | | | 6 | 4.35 | 10, 9 F, 9 F |
| Formulation F | 0.3 | 0 | 1.0 | 3 | 2.1 | 8 M, 8 MD, 8 M |
| | | | | 6 | 4.22 | 8 F, 9 F, 8 M |
| Formulation G | 2.6 | 0 | 3.3 | 3 | 2.1 | 5 F, 7 F, 8 F |
| | | | | 6 | 4.3 | 10, 8 F, 9 F |
| Formulation H | 2.6 | 0 | 0 | 3 | 2.05 | 8 M, 8 MD, 7 M |
| | | | | 6 | 4.44 | 2 F, 9 F, 6 F |

¹Each formulation is applied in triplicate.
²Based on the total weight of the final formulation.
³Measured with a wet film gauge (calling card type) from Gardco; Paul N. Gardner Company, Inc., FL.
⁴Average dry film thickness of three panels; Dry film thickness of coatings is measured with a coating thickness gage (Positector 6000, DeFelsko, NY).
⁵Three values are provided for each formulation.

### Example 11

The aniline trimer identified in Example 1 is added to Interbond 998 (6.3% by weight of the aniline trimer in the final composition). The resulting coating composition comprises Part A (69.5% by weight in final composition) and Part B (20.4% by weight in final composition). Parts A and B are mixed before use. Benzyl alcohol is added to the above composition at a concentration of 3.2% by weight of the final composition. Salicylic acid is also added to the composition at a concentration of 0.6% by weight of the final composition. The resulting coating composition may be referred as Formulation I. Formulation I can be used to protect metal surfaces from corrosion.

### Example 12

The aniline trimer identified in Example 1 is doped with salicylic acid and added to Interbond 998 (5.1% by weight of the doped aniline trimer in the final composition). The resulting coating composition comprises Part A (68.4% by weight in final composition) and Part B (22.4% by weight in final composition). Parts A and B are mixed before use. Benzyl alcohol is added to the above composition at a concentration of 2.8% by weight in the final composition. The concentration of salicylic acid in the final composition is 1.2% by weight. The resulting coating composition may be referred as Formulation J. Formulation J can be used to protect metal surfaces from corrosion.

### Example 13

The aniline trimer identified in Example 1 is added to Interbond 998 (5.1% by weight aniline trimer in the final composition). The resulting coating composition comprises Part A (65.1% by weight in final composition) and Part B (26.6% by weight in final composition). Parts A and B are mixed before use. Benzyl alcohol is added to the above composition at a concentration of 2.7% by weight of the final composition. Salicylic acid is also added at a concentration of 0.5% by weight in the final composition. The resulting coating composition may be referred as Formulation K. Formulation K can be used to protect metal surfaces from corrosion.

### Example 14

The aniline trimer identified in Example 1 is added to Interbond 998 (7.1% by weight of the aniline trimer in the final composition). The resulting coating composition comprises Part A (64.8% by weight in the final composition) and Part B (24.2% by weight in the final composition). Parts A and B are mixed before use. Benzyl alcohol is added to the above composition at a concentration of 3.2% by weight in final composition. Salicylic acid is also added at a concentration of 0.6% by weight of the final composition. The resulting coating composition may be referred as Formulation L. Formulation L can be used to protect metal surfaces from corrosion.

### Example 15

The aniline trimer identified in Example 1 is added to Interbond 998 (5.0% by weight of aniline trimer in the final composition). The resulting coating composition comprises Part A (64.3% by weight in the final composition) and Part B (26.3% by weight in the final composition). Parts A and B are mixed before use. Benzyl alcohol is added to the above composition at a concentration of 3.2% by weight in the final composition. Salicylic acid is also added to the composition at a concentration of 1.2% by weight of the final composition. The resulting coating composition may be referred as Formulation M. Formulation M can be used to protect metal surfaces from corrosion.

### Example 16

Formulations I, J, K, L and M are used to coat cold rolled steel panels and their anticorrosion performance is compared to Interbond 998 (control coating). Rating of the anticorrosion capacity of the formulations is performed according to ASTM D1654-08. The coated specimens are initially scribed with a scribing tool (v shape) until penetration through to the bare metal substrate. After exposure of the test specimens to accelerated corrosion testing (according to ASTM B117) rating of the corrosion performance is performed by removing the coating along the scribe (by mechanical means with a spatula or a blade) and by measuring the distance corrosion has traveled away from the original scribe. Note that the higher the rust creepage rating number (Table 4 below), the better the anticorrosion performance of a coating. The rating of the degree of blistering of the formulations subjected to accelerated corrosion is performed according to ASTM D714-02 where the size of the blisters on the coating is expressed on a numerical scale from 10 to 0, in which 10 represents no blistering and 9 represents the smallest size of blister easily seen by the unaided eye. Rating values of 8, 7, 6, down to 1 correspond to progressively larger blister sizes. The frequency of the blisters shown on a coating are designated with the letters D, MD, M, and F which correspond to dense, medium dense, medium, and few respectively. The formulations evaluated during this study are run in triplicate.

TABLE 4
Rating of the degree of blistering and scribe creepage of cold rolled
steel panels coated with formulations I, J, K, L, M and Interbond 998 (control)

| | Dry Film | Degree of Blistering Rating | | | Scribe Creepage Rating | | |
|---|---|---|---|---|---|---|---|
| | Thickness | (ASTM D714-02) | | | (ASTM D1654-08) | | |
| Formulation | (mils avg) | 500 hrs¹ | 1000 hrs¹ | 1500 hrs¹ | 500 hrs¹ | 1000 hrs¹ | 1500 hrs¹ |
| Interbond 998 | 0.90 | 4 F, 7 M | 6 M, 4 F | 5 MD, 4 D | 3 | 4 | 3 |
| | 2.00 | 7 M, 7 F | 7 M | 6 MF, 7 MD | 5 | 4 | 4 |
| | 4.10 | 10, 7 F | 7 F, 6 F | 4 F, 7 MD | 4 | 5 | 2 |
| | 9.96 | 6 F | 8 F, 6 F | 5 MF, 6 M | 6 | 3 | — |
| Formulation I | 0.99 | 10, 9 F | 9 MD | 9 MD | 7 | 5 | 5 |
| | 2.19 | 10 | 8 F | 9 MD | 7 | 5 | 4 |
| | 4.57 | 10 | 9 F, 8 F | 9 MD | 6 | 5 | 5 |
| Formulation J | 0.95 | 9 F | 8 F, 9 F | 8 MD | 7 | 6 | 5 |
| | 2.14 | 10 | 8 F | 7 M | 8 | 5 | 5 |
| | 4.05 | 10 | 10 | 8 F | 7 | 5 | 5 |
| | 10.48 | 10 | 10 | 10 | — | 5 | 6 |
| Formulation K | 0.91 | 8 M, 9 M | 8 MD | 7 M, 8 M | 5 | 5 | 4 |
| | 2.03 | 10 | 9 M, 10 | 8 F | 5 | 6 | 4 |
| | 4.04 | 10, 8 F | 9 MD | 8 F, 7 F | 6 | 6 | 4 |
| | 10.08 | 10 | 10 | 10 | 7 | 7 | 4 |
| Formulation L | 0.84 | 9 F | 8 M, 9 M | 8 M | 7 | 6 | 4 |
| | 1.99 | 10 | 9 F | 7 F | 6 | 6 | 4 |
| | 4.08 | 10 M, 10 | 10 | 10 | 6 | 7 | 5 |
| | 10.78 | 10 | 10 | 10 | 7 | 6 | 5 |
| Formulation M | 0.92 | 9 M, 8 M | 7 MD | 7 M | 6 | 5 | 4 |
| | 2.08 | 7 M, 8 F | 7 M, 7 MF | 8 F, 7 F | 7 | 5 | 4 |
| | 4.06 | 10 | 8 F | 8 F | 7 | 6 | 4 |
| | 10.87 | 10 | 10, 9 F | 10 | 7 | 7 | 6 |

¹Average rating of at least two panels

### Example 17

Formulations I and J are used to coat cold rolled steel panels and their anticorrosion performance is compared to Interbond 998 (control coating). Rating of the anticorrosion capacity of the formulations is performed according to ASTM standard D1654-08. The coated specimens are initially scribed with a scribing tool (v shape) until penetration through to the bare metal substrate. After exposure of the test specimens to accelerated corrosion testing according to ASTM B117. Rating of the corrosion performance is performed by removing the coating along the scribe (by mechanical means with a spatula or a blade) and by measuring the distance corrosion has traveled away from the original scribe. Note that the higher the rust creepage rating number (Table 5 below), the better the anticorrosion performance of a coating. The rating of the degree of blistering of the formulations subjected to accelerated corrosion has been performed according to ASTM D714-02 where the size of the blisters on the coating is expressed on a numerical scale from 10 to 0, in which 10 represents no blistering and 9 represents the smallest size of blister easily seen by the unaided eye. Rating values of 8, 7, 6, down to 1 correspond to progressively larger blister sizes. The frequency of the blisters shown on a coating are designated with the letters D, MD, M, and F which correspond to dense, medium dense, medium, and few respectively. The formulations evaluated during this study are run in triplicate.

TABLE 5
Rating of the degree of blistering and scribe creepage of cold rolled
steel panels coated with formulations I, J and Interbond 998 (control).

| | Dry Film | Scribe Creepage Rating | | | | Degree of Blistering Rating | | | |
|---|---|---|---|---|---|---|---|---|---|
| | Thickness | (ASTM D 1654-08) | | | | (ASTM D714-02) | | | |
| Formulation | (mils) | 500 hrs | 750 hrs | 1000 hrs | 1500 hrs | 500 hrs | 750 hrs | 1000 hrs | 1500 hrs |
| Interbond 998 | 0.85 | 4 | 3 | 3 | 4 | 4 M | 4 to 6 D | 2 to 6 MD | 2 to 4 MD |
| | 0.97 | 4 | 5 | 3 | 4 | 4 to 6 M | 2 to 6 D | 2 to 6 MD | 2 to 4 MD |
| | 0.92 | 4 | 4 | 3 | 4 | 2 to 4 M | 2 to 6 D | 2 to 6 MD | 2 to 4 MD |
| | 0.93 | 5 | 4 | 3 | 4 | 4 to 6 M | 2 to 6 D | 2 to 6 MD | 2 to 4 MD |
| Formulation I | 1.04 | 7 | 6 | 6 | 5 | 8 F | 8 F | 6 M | 4 M |
| | 0.96 | 7 | 5 | 6 | 5 | 6 to 8 M | 8 M | 6 M | 4 M |
| | 0.90 | 7 | 6 | 6 | 5 | 8 M | 8 M | 6 M | 4 to 6 M |
| | 0.97 | 7 | 7 | 6 | 6 | 8 M | 8 M | 6 M | 6 M |
| Formulation J | 0.87 | 5 | 6 | 6 | 5 | 6 to 8 F | 8 M | 6 F | 8 M |
| | 0.91 | 5 | 5 | 6 | 6 | 6 to 8 F | 8 F | 6 M | 2 to 4 M |
| | 0.95 | 5 | 5 | 6 | 6 | 6 to 8 M | 8 M | 6 M | 2 to 4 M |
| | 0.93 | 5 | 6 | 6 | 5 | 6 to 8 M | 8 M | 4 to 6 M | 2 to 4 M |

### Example 18

Formulations K and L are used to coat cold rolled steel panels and their anticorrosion performance is compared to Interbond 998 (control coating). Rating of the anticorrosion capacity of the formulations was performed according to ASTM D1654-08. The coated specimens are initially scribed with a scribing tool (v shape) until penetration through to the bare metal substrate. After exposure of the test specimens to accelerated corrosion testing according to ASTM B117. Rating of the corrosion performance is performed by removing the coating along the scribe (by mechanical means with a spatula or a blade) and by measuring the distance corrosion has traveled away from the original scribe. Note that the higher the rust creepage rating number (Table 6 below), the better the anticorrosion performance of a coating. The rating of the degree of blistering of the formulations subjected to accelerated corrosion has been performed according to ASTM D714-02 where the size of the blisters on the coating is expressed on a numerical scale from 10 to 0, in which 10 represents no blistering and 9 represents the smallest size of blister easily seen by the unaided eye. Rating values of 8, 7, 6, down to 1 correspond to progressively larger blister sizes. The frequency of the blisters shown on a coating are designated with the letters D, MD, M, and F which correspond to dense, medium dense, medium, and few respectively. The formulations evaluated during this study are run in triplicate.

TABLE 6
Rating of the degree of blistering and scribe creepage of cold rolled
steel panels coated with formulations K, L and Interbond 998 (control).

| | Dry Film | Scribe Creepage Rating | | | | Degree of Blistering Rating | | | |
|---|---|---|---|---|---|---|---|---|---|
| | Thickness | (ASTM D 1654-08) | | | | (ASTM D714-02) | | | |
| Formulation | (mils) | 500 hrs | 750 hrs | 1000 hrs | 1500 hrs | 500 hrs | 750 hrs | 1000 hrs | 1500 hrs |
| Interbond 998 | 4.04 | 6 | 5 | 5 | 5 | 6 F | 2 to 4 F | 2 F | 2 F |
| | 4.11 | 6 | 5 | 4 | 4 | 6 F | 2 F | 2 F | 2 F |
| | 4.13 | 6 | 4 | 4 | 4 | 6 F | 2 F | 2 to 4 F | 2 to 4 F |
| | 4.13 | 4 | 5 | 4 | 4 | 6 F | 2 F | 2 to 4 F | 2 to 4 F |
| Formulation K | 4.10 | 7 | 7 | 6 | 6 | 10 | 4 F | 4 to 6 F | 4 to 6 F |
| | 4.12 | 7 | 7 | 6 | 6 | 10 | 4 F | 6 F | 6 F |
| | 4.08 | 7 | 6 | 6 | 6 | 4 F | 4 F | 6 F | 6 F |
| | 4.12 | 7 | 7 | 7 | 7 | 4 F | 6 F | 4 to 6 F | 4 to 6 F |
| Formulation L | 4.20 | 7 | 7 | 6 | 6 | 10 | 8 F | 6 F | 6 F |
| | 4.14 | 7 | 7 | 6 | 5 | 10 | 10 | 8 F | 8 F |
| | 4.21 | 8 | 7 | 6 | 5 | 10 | 10 | 8 F | 8 F |
| | 4.12 | 7 | 6 | 7 | 6 | 10 | 8 F | 6 F | 6 F |

### Example 19

The aniline trimer identified in Example 1 is added to Interbond 998 (6.3% by weight of the aniline trimer in the final composition). The resulting coating composition comprises Part A (69.5% by weight in final composition) and Part B (20.4% by weight in final composition). Parts A and B are mixed before use. Acetone is added to the above composition at a concentration of 3.2% by weight of the final composition. Salicylic acid is also added to the composition (0.6% by weight of the final composition). The coating composition may be referred as Formulation N. Formulation N can be used to protect metal surfaces from corrosion.

### Example 20

The aniline trimer identified in Example 1 is added to Interbond 998 (6.3% by weight of the aniline trimer in the final composition). The resulting coating composition comprises Part A (69.5% by weight in final composition) and Part B (20.4% by weight in final composition). Parts A and B are mixed before use. Hexane is added to the above composition at a concentration of 3.2% by weight. Salicylic acid is also added to the composition at a concentration of 0.6% by weight of the final composition. The resulting coating composition may be referred as Formulation O. Formulation O can be used to protect metal surfaces from corrosion.

### Example 21

The aniline trimer identified in Example 1 is added to Interbond 998 (6.3% by weight of the aniline trimer in the final composition). The resulting coating composition comprises Part A (69.5% by weight in final composition) and Part B (20.4% by weight in final composition). Parts A and B are mixed before use. Methyl ethyl ketone is added to the above composition at a concentration of 3.2% by weight in the final composition. Salicylic acid is added at a concentration of 0.6% by weight of the final composition. The resulting coating composition may be referred as Formulation P. Formulation P can be used to protect metal surfaces from corrosion.

### Example 22

The aniline trimer identified in Example 1 is added to Interbond 998 (6.3% by weight aniline trimer in the final composition). The resulting coating composition comprises Part A (69.5% by weight in final composition) and Part B (20.4% by weight in final composition). Parts A and B are mixed before use. Xylene is added to the above composition at a concentration of 3.2% by weight of the final composition. Salicylic acid is also added at a concentration of 0.6% by weight in the final composition. The resulting coating composition may be referred as Formulation Q. Formulation Q can be used to protect metal surfaces from corrosion.

### Example 23

The aniline trimer identified in Example 1 is added to a commercially available epoxy-amine coating composition (5.7% by weight of the aniline trimer in the final composition). The resulting coating composition comprises Part A (49.0% by weight of an epoxy resin in the final composition) and Part B (44.5% by weight amine crosslinker in the final composition). Parts A and B are mixed before use. Salicylic acid is added at a concentration of 0.6% by weight of the final composition. The resulting coating composition may be referred as Formulation R. Formulation R can be used to protect metal surfaces from corrosion.

### Example 24

The aniline trimer identified in Example 1 is added to a commercially available epoxy-amine coating composition (5.9% by weight of the aniline trimer in the final composition). The resulting coating composition comprises Part A (49.0% by weight epoxy resin in final composition) and Part B (44.5% by weight amine crosslinker in final composition). Parts A and B are mixed before use. Salicylic acid is added at a concentration in the final composition of 0.6% by weight. The resulting coating composition may be referred as Formulation S. Formulation S can be used to protect metal surfaces from corrosion.

### Example 25

The aniline trimer identified in Example 1 is added to a commercially available epoxy-amine coating composition (5.7% by weight aniline trimer in the final composition). The resulting coating composition comprises Part A (47.3% by weight epoxy resin in final composition) and Part B (42.9% by weight amine crosslinker in final composition). Parts A and B are mixed before use. Benzyl alcohol is added to the above composition at a concentration of 2.8% by weight of the final composition. Acetone is also added at a concentration of 1.3% by weight in the final composition. The resulting coating composition may be referred as Formulation T. Formulation T can be used to protect metal surfaces from corrosion.

### Example 26

The aniline trimer identified in Example 1 is doped with salicylic acid and added to Interbond 998 (6.3% by weight of the doped aniline trimer in the final composition). The resulting coating composition comprises Part A (69.5% by weight in final composition) and Part B (20.4% by weight in final composition). Parts A and B are mixed before use. Benzyl alcohol is added to the above composition at a concentration of 3.2% by weight in the final composition. The concentration of salicylic acid in the final composition is 0.6% by weight. The resulting coating composition may be referred as Formulation U. Formulation U can be used to protect metal surfaces from corrosion.

### Example 27

The aniline trimer identified in Example 1 is added to Interbond 998 (6.3% by weight aniline trimer in the final composition). The resulting coating composition comprises Part A (69.5% by weight in final composition) and Part B (20.4% by weight in final composition). Parts A and B are mixed before use. Benzyl alcohol is added to the above composition at a concentration of 3.2% by weight of the final composition. Triethylamine is also added at a concentration of 0.6% by weight in the final composition. The resulting coating composition may be referred as Formulation V. Formulation V can be used to protect metal surfaces from corrosion.

### Example 28

The aniline trimer identified in Example 1 is doped with salicylic acid and added to Interbond 998 (5.1% by weight of the doped aniline trimer in the final composition). The resulting coating composition comprises Part A (69.5% by weight in final composition) and Part B (20.4% by weight in final composition). Parts A and B are mixed before use. Benzyl alcohol is added to the above composition at a concentration of 3.2% by weight in the final composition. The concentration of salicylic acid in the final composition is 0.6% by weight. The resulting coating composition may be referred as Formulation W. Formulation W can be used to protect metal surfaces from corrosion.

### Example 29

10 g of the aniline trimer identified in Example 1 are dissolved in 5 g of benzyl alcohol. 1 g of salicylic acid is added to the resulting mixture. The resulting mixture may be referred as Formulation X. Formulation X can be added to a variety of commercially available epoxy-amine coating compositions to improve their anticorrosion performance.

### Example 30

6.3 g of the aniline trimer identified in Example 1 are dissolved in 3.2 g of benzyl alcohol. The resulting mixture is mixed with 20.4 g of a commercially available amine crosslinker (active amine hydrogen equivalent weight 150-180). 0.6 g of salicylic acid is added to the above mixture. The resulting mixture may be referred as Formulation Y. Formulation Y can be combined with commercially available epoxy resins to provide a coating that cures at ambient temperatures and can protect metal surfaces from corrosion.

### Example 31

The aniline trimer identified in Example 1 is added to a commercially available epoxy-amine coating (4.3% by weight of the aniline trimer in the final composition). An amine capped aniline tetramer (MW: 379) is added to Interbond 998 (2% by weight of the aniline tetramer in the final composition). The resulting coating composition comprises Part A (epoxy resin, 69.5% by weight in final composition) and Part B (amine crosslinker, 20.4% by weight in final composition). Parts A and B are mixed before use. Benzyl alcohol is added to the above composition at a ratio of 3.2% by weight in final composition. Salicylic acid is also added to the composition (0.6% by weight in final composition). The resulting coating composition may be referred as Formulation Z. Formulation Z can be used to protect metal surfaces from corrosion.

### Example 32

A low molecular weight aniline oligomer (Average MW<660) is added to Interbond 998 (6.3% by weight aniline oligomers in the final composition). The resulting coating composition comprises Part A (epoxy resin, 69.5% by weight in final composition) and Part B (amine crosslinker, 20.4% by weight in final composition). Parts A and B are mixed before use. Benzyl alcohol is added to the above composition at a concentration of 3.2% by weight in final composition. Salicylic acid is also added to the composition (0.6% by weight in final composition). The resulting mixture may be referred as Formulation AA. Formulation AA can be used to protect metal surfaces from corrosion.

While the invention has been explained in relation to various embodiments, it is to be understood that various modifications thereof may become more apparent to those skilled in the art upon reading this specification. Therefore, it is to be understood that the invention includes all such modifications that may fall within the scope of the appended claims.

1. A composition, comprising:
an aniline oligomer with at least one amine functional group; and
a catalyst, wherein the catalyst comprises a cationic catalyst, anionic catalyst, imidazole, ketone, alcohol, tertiary amine, secondary amine, alkoxide, phenol, carboxylic acid, Lewis acid, carboxylic acid anhydride, sulfur containing compound, metal halide, a salt or complex of any of the foregoing catalysts, or a mixture of two or more of any of the foregoing.

2. The composition of claim 1 wherein the composition further comprises a resin that is reactive with the aniline oligomer, the catalyst being present at an effective level to cure the composition at a temperature in the range from about 0° C. to about 40° C.

3. The composition of claim 1 wherein the aniline oligomer comprises aniline trimer, tetramer, pentamer, hexamer, heptamer, octamer, nonamer, decamer, or a mixture of two or more thereof.

4. The composition of claim 1 wherein the aniline oligomer comprises a mixture of an aniline trimer and an aniline tetramer.

5. The composition of claim 1 wherein the aniline oligomer comprises a compound represented by the formula: 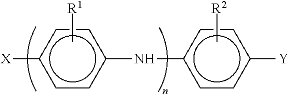
where X and Y independently comprise —NH₂, —H, —C₆H₄NH₂, —OC₆H₄NH₂, alkyl, aryl, —OH or —OR; R¹ and R² independently comprise —H, —OH, —COOH, alkyl, aryl, alkoxy, halogen, —NO₂, —NH₂, or —NHC₆H₄; at least one of X, Y, R¹ or R² is —NH₂; and n is a number in the range from 2 to about 20.

6. The composition of claim 1 wherein the aniline oligomer comprises the reaction product of 1,4-benzenediamine an aniline oligomer.

7. The composition of claim 1 wherein the aniline oligomer has a molecular weight in the range from about 100 to about 2000.

8. The composition of claim 1 wherein the aniline oligomer comprises N,N′-bis(4-aminophenyl)-1,4-quinonenediimine.

9. The composition of claim 1 wherein the aniline oligomer is doped with an organic acid and/or a mineral acid.

10. The composition of claim 9 wherein the aniline oligomer is doped with salicylic acid, p-toluene sulfonic acid, methane sulfonic acid, citric acid, hydrochloric acid, phosphoric acid, sulfuric acid, or a mixture of two or more thereof.

11. The composition of claim 9 wherein the aniline oligomer is doped with salicylic acid.

12. The composition of claim 2 wherein the resin comprises an epoxy resin, a urethane resin, an acrylic resin, a polyimide resin, a urethane functionalized resin, a carboxylic acid functionalized resin, an anhydride functionalized resin, or a mixture of two or more thereof.

13. The composition of claim 2 wherein the resin comprises an amine curable epoxy resin.

14. The composition of claim 2 wherein the resin comprises Bisphenol A epoxy resin, Bisphenol F epoxy resin, Novolac epoxy resin, aliphatic epoxy resin, glycidylamine epoxy resin, or a mixture of two or more thereof.

15. The composition of claim 1 wherein the catalyst comprises manganese nitrate, iron (III) nitrate, magnesium nitrate, zinc nitrate, magnesium perchlorate, calcium perchlorate, zinc perchlorate, cobalt perchlorate, a trifluoromethanesulfonic acid salt, boron trifluoride, methanol, ethylene glycol, glycerol, triethanolamine, phenol, bisphenol A, resorcinol, 4-bromothiophenol, 2-nitro-phenol, 3-nitro-phenol, 4-nitro-phenol, 2,4-dinitro-phenol, 2-chloro-phenol, 2,4-dichloro-phenol, 2,4,5-trichloro-phenol, 2,4,5,6-tetrachloro-phenol, p-chlororesorcinol, p-chlorophenol, p-bromophenol, octylphosphoric, toluenesulfonic, phenolsulfonic, benzenesulfonyl chloride, benzoic acid, thiobenzoic acid, m-hydroxy-benzoic acid, p-hydroxy-benzoic acid, 2,4-dihydroxy-benzoic acid, 2,5-dihydroxy-benzoic acid, 2-bromo-benzoic acid, 2-chloro-benzoic acid, 4-chloro-benzoic acid, 2,4-dichloro-benzoic acid, 2,4,5-trichloro-benzoic acid, salicylic acid, thiosalicylic acid, 2-methyl-benzoic acid, 2-mercapto-benzoic acid, 2-nitro-benzoic acid, 3,5-dinitro-benzoic acid, 2-chloro 5-nitro-benzoic acid, o-phthalic acid, m-phthalic acid, p-phthalic acid, trimellitic acid, lactic acid, propionic acid, succinic acid, triethylamine, tetramethylethylenediamine, benzene dimethylamine, 1-methyl imidazole, 2-methyl imidazole, 2-ethyl-4-methyl imidazole, or a mixture of two or more thereof.

16. The composition of claim 1 wherein the catalyst comprises salicylic acid, N-methylimidazole, benzyl alcohol, triethylene amine, or a mixture of two or more thereof.

17. The composition of claim 1 wherein the composition further comprises an aliphatic amine.

18. The composition of claim 17 wherein the aliphatic amine comprises ethylenediamine, diethylene triamine, n-aminoethyl ethanolamine, hexamethylenediamine, trimethylhexamethylenediamine, diethylenetriamine, triethylenetriamine, tetraethylenepentamine, N,N-dimethylpropylenediamine, N,N-diethyl-1,3-propylenediamine, or a mixture of two or more thereof.

19. The composition of claim 1 wherein the composition further comprises a cycloaliphatic amine.

20. The composition of claim 19 wherein the cycloaliphatic amine comprises 1,2-diaminocyclohexane, 1,3-diaminocyclohexanes, 1,4-diaminocyclohexane, 1,2-diamino-4-ethylcyclohexane, 1,3-bis(aminomethyl)cyclohexane, 1-4-bis(aminomethyl)cyclohexane, N-amino-ethylpiperazine, isophoronediamine, or a mixture of two or more thereof.

21. The composition of claim 1 wherein the composition further comprises a solvent.

22. The composition of claim 21 wherein the solvent comprises acetonitrile, N-methylpyrolidone, N-ethyl pyrolidone, dimethylsulfoxide, dimethyl formamide, ethanolamine, benzyl alcohol, ethanol, methanol, isopropanol, acetone, ethyl acetate, butyl acetate, propyl acetate, ethylene glycol monobutyl ether, diethylene glycol, ethylene glycol, glycerin, diethylene glycol dimethyl ether, dimethyl ether, dimethyl formamide, formamide, methyl imidazole, tetrahydrofuran, methyl ethyl ketone, methyl t-butyl ether, pyridine, methylene chloride, pentane, hexanes, heptane, xylenes, toluene, or a mixture of two or more thereof.

23. The composition of claim 1 wherein the composition further comprises an effective amount of an oxidizing agent to maintain the aniline oligomer in its pernigraniline form.

24. The composition of claim 23 wherein the oxidizing agent comprises a compound that contains an oxygen-oxygen singe bond, a peroxide group, a peroxide ion, or a mixture of two or more thereof.

25. The composition of claim 23 wherein the oxidizing agent comprises hydrogen peroxide, an organic peroxide, an inorganic peroxide, a peroxy acid, a persulfate, a perchlorate, a halogenated metal acid, an azo-initiator, a redox initiator, or a mixture of two or more thereof.

26. The composition of claim 23 wherein the oxidizing agent comprises peroxy carboxylic acid, cummene hydroperoxide, peroxide salt, slkali or alkaline earth metal peroxide, peroxy monosulfuric acid, peroxy disulfuric acid, potassium, sodium and/or ammonium persulfate, ammonium peroxydisulfate, potassium perchlorate, potassium iodinate, chlorolaurate acid, azobisisobutyronitrile, azobiscyanovaleriane acid, 2,2′-azobis(2-methylpropion-amidin)dihydrochloride, t-butyl hydroxide, t-butyl peroxide, cumol hydroperoxide, t-butyl peroxopivalate, isopropyl benzomonohydroperoxide, dibenzoyl peroxide, dicumylperoxide, alkylhydroperoxide, bicyclohexylperoxydicarbonate, dicetylperoxydicarbonate, potassium dichromate, sodium dichromate, ammonium dichromate, ferric sulfonate, cupric sulfonate, lead oxide, or a mixture of two or more thereof.

27. The composition of claim 1 wherein the composition further comprises an effective amount of a reducing agent to maintain the aniline oligomer in its leucoemeraldine form.

28. The composition of claim 27 wherein the reducing agent comprises an element or compound that donates an electron to another species.

29. The composition of claim 27 wherein the reducing agent comprises a compound that donates hydrogen to a molecule.

30. The composition of claim 27 wherein the reducing agent comprises hydrazine, sodium borohydride, atomic hydrogen, lithium aluminum hydride, sodium amalgam, diborane, tin (II) chloride, sulfite compounds, zinc-mercury amalgam, diisobutylaluminum hydride, oxalic acid, formic acid, ascorbic acid, phosphites, hypophopshites, phosphorous acid, iron (II) sulfate, carbon monoxide, carbon, or a mixture of two or more thereof.

31. The composition of claim 2 wherein a polymer network is formed upon reacting the resin with the aniline oligomer.

32. The composition of claim 2 wherein the composition is applied to a substrate at a wet film thickness of about 0.1 to about 100 mils.

33. A coating composition, comprising:
an aniline oligomer with at least one amine functional group;
a resin that is reactive with the aniline oligomer; and
an effective amount of a catalyst to cure the coating composition at a temperature in the range from about 0° C. to about 40° C.;
wherein the catalyst comprises a cationic catalyst, anionic catalyst, imidazole, ketone, alcohol, tertiary amine, secondary amine, alkoxide, phenol, carboxylic acid, Lewis acid, carboxylic acid anhydride, sulfur containing compound, metal halide, a salt or complex of any of the foregoing catalysts, or a mixture of two or more of any of the foregoing.

34. A coating composition comprising N,N′-bis-(4-aminophenyl)-1,4-guinonenediimine; an epoxy resin; an amine crosslinker; and an effective amount of salicylic acid to cure the composition at a temperature in the range from about 0° C. to about 40° C.

35. A coating composition comprising: an aniline trimer; an epoxy resin; and a catalyst; wherein the catalyst is suitable for catalyzing a reaction between the aniline trimer and the epoxy resin at a temperature in the range from 0° C. to about 30° C.

36. The composition of claim 35 wherein the catalyst comprises a cationic catalyst, an anionic catalyst, imidazole, tertiary amine, secondary amine, alkoxide, phenol, carboxylic acid, Lewis acid, metal halide, or a combination of two or more thereof.

37. The composition of claim 35 wherein the catalyst comprises: a nitrate of manganese, iron (III), magnesium, and/or zinc; a perchlorate of magnesium, calcium, zinc and/or cobalt; and/or a magnesium, ammonium, calcium, scandium and/or bismuth salt of trifluoromethanesulfonic acid, triethylamine, salicylic acid, or a combination of two or more thereof.

38. A metal substrate and the composition of claim 2 applied to the metal substrate.
